(19) United States
(12) Patent Application Publication
(10) Pub. No.: US 2008/0109379 A1
(43) Pub. Date: May 8, 2008

(54) Cellular automata financial trading method and system

(76) Inventors: Abraham Cofnas, Longwood, FL (US); Andrew Adamatzky, (US)

Correspondence Address: Matthew G. McKinney, Suite 150, 338 W. Morse Blvd., Winter Park, FL, 32789, US

(21) Appl. No.: 11/546,694

(22) Filed: Oct. 12, 2006

(51) Int. Cl. G06Q 40/00

(52) U.S. Cl. 705/36 R

(57) ABSTRACT

The invention claims a new method of generating financial trading alerts, improved buying and selling decisions, and financial controls using cellular automata. An array known as a Virtual Trading Neighborhood (“VTN”) is comprised of cells that comprise financial data received from active traders including intentions to buy and sell and also actual buy and selling actions. The VTN further comprises a cellular automata cell that is programmed with preselected rules. The cellular automata cell generates an output based on the prior trading actions of the surrounding neighbor cells of the VTN. The resulting buy or sell trading alerts are provided to authorized users to manage financial trading risks and increase profits.

### BACKGROUND OF THE INVENTION

1. Field of the Invention

The present invention relates generally to financial trading, and more specifically to methods of using cellular automata logic to generate output for financial alerts, improving buying and selling decisions, and financial controls.

2. Background of the Invention

In this age of computerization and the Internet, trading financial instruments involves almost universally the initiation of a trading order at a computer and its processing at financial firm with the ultimate result being a record of the trade in a financial account. Millions of trading orders are processed every hour around the world. The results are measured in profits and losses in individual accounts throughout the world. Each trading decision is a judgment reflecting a complex combination of factors that leads to the decision to buy or sell an instrument.

It has been the quest of many to improve the ability to accurately predict price movements. Throughout the history of financial markets, many of the tools of science and mathematics have been applied to the quest of improving prediction and analysis of price action. The benefit of gaining improvements in financial analysis goes beyond the potential profits that will accrue to individuals. Better knowledge of price patterns and the dynamics of human trading decisions will also help minimize market crashes and instability.

Current trading systems and signals, however, are based on algorithms designed to analyze price behavior and then generate buying or selling signals attempting to predict profitable results. Stock market trading and forecasting systems all share this algorithmic logic and structure. As a result, these existing methods have inherent limitations. Predicting price action remains an elusive goal because markets are very complex and accurate models of prediction may be impossible due to the irreducible complexity of the market. This is known as the “Lorenz butterfly effect”, where in complex phenomena, the smallest factors, can lead to inaccurate predictions.

There are obvious advantages to improving predictive accuracy in trading financial trading instruments. But there is also accruing to investors substantial public benefit in developing new methods of financial alerts. A key benefit is the potential to minimize the occurrence of sudden or large losses in trading. The health of the financial markets in the world is compromised when price behavior shifts suddenly. Market panics and crashes in the 20^{th} century resulted in public policy actions to minimize future risk. These actions centered on placing controls on what kind of trading was permissible. Volume levels in the market trigger these financial controls which are arbitrary and highly inefficient due to the inherent complexity of financial markets. Accordingly, what is needed in the art is improvements in methods of generating alerts for individuals, institutions, and financial exchanges engaged in the trading of any financial instruments such as equities, bonds, futures contracts, currencies, and derivatives. The potential for significant improvement and financial alert effectiveness is arrived by detecting and human trading intentions and decisions.

There is also a need in the art for improved recommendations for trading decisions related to buying and selling

Another need exists in the art to provide techniques to generate financial alerts based on recognition of human trading patterns.

Another need exists in the art to provide techniques to detect unstable and unusual trading patterns.

Another need exists in the art to provide techniques to manage financial trading risks.

Another need exists in the art to provide for financial trading floors to arrange where traders sit to improve results.

Another need exists in the art are to provide financial alerts to individual traders based on mimicking of expert trader intentions and trading behavior thereby increasing the skill potential of individual traders and potentially their profitability.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF THE INVENTION

The present invention comprises a method using cellular automata to process existing trading data from traders to generate unprecedented output that improves a wide range of future financial trading decisions and alerts for both individual traders and institutions. However, the method and system of the present invention is not a predictive system based on input of market data and it is not algorithmic. Rather, the method and system instead uses cellular automata logic to mimic human trading behavior. Based on the observations of human trading behavior decisions, the present invention generates an output of buy and sells decisions or simply an alert signal. This use of cellular automata as a basis for evaluating trading behavior provides a different basis for generating trading decisions and alerts and forms a new class of financial alerts over the prior art. The method of using cellular automata logic to process financial trading signals is therefore a paradigm shift in the logic behind trading decisions and alerts. It creates a new kind of technical analysis that features cellular automata interacting with human traders and data.

Trading output generated through the use of cellular automata is based on recognition of real-time trading patterns and therefore offers the potential to provide individuals, financial institutions and exchanges, new abilities for early detection of information cascades and unstable or unusual trading patterns. The claimed methods using cellular automata can be used to minimize panic buying or selling; detect computer program based trading that may be disruptive; and provide methods for offsetting losing trends. Financial institutions as well as individuals may significantly benefit by being able to develop and access cellular automata based alerts.

The trading alerts generated by the present invention using cellular automata can provide offsetting trading signals and orders thereby providing greater stability to institutions and exchanges. Simulations on trading data using cellular automata programmed with preselected rules have shown that the method of using cellular automata logic reduces the risk of large or sudden losses by observing patterns of trading and generating alerts to offset and minimize unstable patterns of trading. If an imbalance between buyers and sellers is detected, the present invention is used to generate signals that introduce a shift in the balance between buyers and sellers, thereby providing an unprecedented tool for financial controls. Such results have a profound impact on the ability to manage financial trading risks and increase the stability of financial markets.

The method of the present invention is a unique application of cellular automata logic to financial markets and trading decisions never before used. In the prior art cellular automata has been used to obtain solutions in encryption, noise reduction, fire control, traffic congestion, etc. Academic research has used cellular automata to simulate stock market patterns. But the present invention uniquely applies cellular automata logic to detect trader intentions and trades to generate output of financial trading decisions that lead to alerts and controls. The invention provides a new use of cellular automata applicable for financial trading in any market that was not before available.

The present invention embeds a Cellular Automata Cell (“CAC”) in a financial data array or Virtual Trading Neighborhood (“VTN”). Virtual trader cells that contain relevant real-time trading data such as intentions to buy and sell and buying and selling decisions surround each CAC. The invention creates a new form of technical analysis of markets and generates output that is based on real-time trader financial behavior and not price action.

An important feature of the present invention is that real trading decisions (buy and sell decisions in real-time) generated by traders is used in the present invention. The source of the trading decisions can be individuals, financial firms, contests, etc. The trading decision data is stored initially in a data structure array with data fields representing buying, selling, quantity, time, and other dimensions related to the trade.

In order to organize the trading data, a data structure is created otherwise known as a VTN. The VTN consists of a two-dimensional array (the array is not limited to two-dimensions in alternative embodiments) or grid of cells representing trading results. There are “n” cells each containing a representation of a buy or sell decision resulting from a trade. At the center of each VTN is the CAC that is programmed to generate buy or sell decisions to a user based only on the behavior of the neighboring trader cells. For example, if the VTN consisted of 8 cells, the CAC could be programmed with a “rule” that generates a buy signal if all 8 of its trader cell neighbors are selling. Another example would be if 5 of the neighboring cells are buying, the CAC would not generate either a buy or sell decision. The “rules” implemented by a CAC in a VTN are preselected by the user. The creation of a VTN with a CAC, is a new method and system for generating output of trading alerts, buying and selling decisions, and financial controls.

The resulting output from the CAC regarding the recommended buying or selling decisions are provided to individual users or other entities so that they can make a final decision to buy or sell as to real financial trades. The CAC can also learn to improve the accuracy of its output.

It is therefore a primary object of the invention to provide techniques to improve financial alerts that minimize the occurrence of sudden or large losses in financial trading.

Another very important object of the invention is to provide techniques to generate financial alerts based on recognition of human trading patterns.

Another important object of the invention is to provide techniques to detect unstable and unusual trading patterns.

Another important object of the invention is to enable improved performance of traders on trading floors.

Still another very important object of the invention is to provide techniques to manage financial trading risks.

Another object of the invention is to provide financial alerts to individual traders based on detecting and mimicking of expert trader intentions and behavior thereby increasing the skill potential of individual traders and potentially their profitability.

These and other important objects, advantages, and features of the invention will become clear as this description proceeds.

The present invention, accordingly, comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is an illustration of a data structure showing data from preselected traders is used to form a Virtual Trading Neighborhood array;

FIG. 2 illustrates a Virtual Trading Neighborhood comprising eight neighbor trader cells and a cellular automata cell;

FIG. 3 is a block diagram of a computer system that may be employed in the present invention;

FIG. 4 is a block diagram of computer software which may be employed in the computer system of FIG. 3, according to the preferred embodiments of the present invention;

FIG. 5. provides a flowchart illustrating logic that may be used to implement a cellular automata system according to preferred embodiments of the present invention; and

FIG. 6. is a block diagram of computer software which may be employed in the computer system of FIG. 3, according to an alternative embodiment of the present invention.

### DETAILED DESCRIPTION OF THE PREFERRED EMBODIMENT

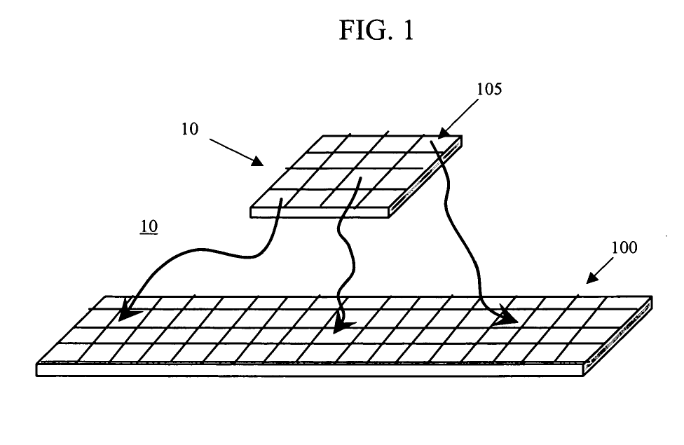

FIG. 1 shows the present invention as a whole by the numeral 10. A trading entity 110 is shown that represents one set of traders out of a pool of traders (not shown). The pool of traders comprises all trading entities and their individual traders (employees). As shown in FIG. 1, the trading entity 110 is comprised of sixteen traders 105 or employees. Out of the sixteen traders 110, data from three preselected traders is shown in forming the Virtual Trading Neighborhood 100. All sixteen traders 110 or none of the traders from the trading entity could be selected but is simply user determined. In the preferred embodiment, several different trading entities 100 are used to complete the Virtual Trading Neighborhood. By using a wide variation of trading entities from various locations, the method of the present invention produces improved output.

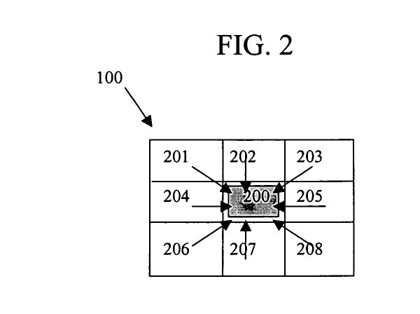

The size of the Virtual Trading Neighborhood 100 array is user determined. In FIG. 2, the Virtual Trading Network 100 is comprised of eight neighbor cells 201, 202, 203, 204, 205, 206, 207, 208. A cellular automata cell 200 is positioned at the center of the Virtual Trading Neighborhood. This is shown for clarity and illustration of the method of the present invention. It is understood by those skilled in the art that the Virtual Trading Neighborhood 100 is not limited to nine total cells as shown in FIG. 2 and further that each of the neighbor cells 201-208 can be programmed as a cellular automata cell as well.

Every neighbor cell 201-208 is assigned a three-component state from the set {BUY, SELL, REST}×Z², where BUY means the cell executes buy action, SELL means the cell executes SELL action, and REST means the cell executes no action at all. Second component of the cell's state represents INTENTION TO BUY and INTENTION TO SELL. Degrees of intentions are discrete numbers.

The cell, imitating an element from the pool of traders, updates its state in discrete time as follows:
Let X(t) be state of neighbor cell X at time step t then at time step t+1 its state will be calculated as follows:

X(t+1)=f(X1(t), . . . X8(t),X(t)),
Where X1(t), . . . X8(t) are states of neighbor cells 201-208.

Each argument of function f consists of three variable representing action Ai(t), intention to buy Bi(t) and intention to sell Ci(t) as Xi(t)=<Ai(t),Bi(t),Ci(t)>, so that the function f has 27 arguments.

The 27-argument function f can be represented by a variety of ways including using a table, which is the most straightforward method. Table 1. shown below indicates that each cell has the capability to represent three values of its state at time t, and the last three columns represent the respective cell value calculated state at time t+1. The degrees of intentions are normalized to fit three values: LOW, MEDIUM, and HIGH. One iteration is shown in TABLE 1. where neighbour cell at X1(t) represents a BUY action, a LOW intention to buy and a HIGH intention to sell. At X2(t), the cell shows its at REST and taking no action, has a MEDIUM intention to buy and MEDIUM intention to sell.

TABLE 1

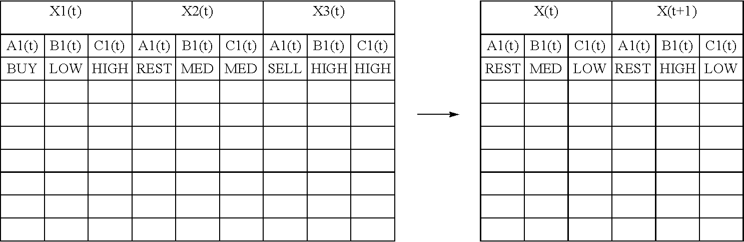

Therefore, it is a semi-totalistic model, where a cell updates its state depending on total sum of neighbors in BUY (SB) and SELL (SS) states, and ratio SIB/SIS of sum of neighbors' intentions to buy (SIB) and intentions to sell (SIS). The function is as follows:

X(t+1)=g(X(t), SB(t), SS(t), SIB(t)/SIS(T)).

In the present invention, a pre-selected number of neighbor cells receive trading data from the trading pool. The pre-selected neighbor cells update their state by the following function:

X(t+1)=h(X(t), Z(t), SB(t), SS(t), SIB(t)/SIS(t)),

Where Z(t) is trading data from traders 105 mapped to a neighbor cell.

Intentions of traders are also changed in time, generally, as a function of actions and intentions their neighbors as represented by the additional functions as

IB(t)=w_{B}(X(t), SIB(t), SIS(t))

IS(t)=w_{S}(X(t), SIB(t), SIS(t))

The cellular automata cell 200 is programmed by the user in accordance with pre-selected rules that determine whether the cellular automata cell generates an output of buy, sell or neither based on the behavior of the neighbor cells 201-208. For example, the cellular automata cell 200 may be programmed with a pre-selected rule that generates an output of a “buy” signal if all eight of its cell neighbors 201-208 are selling. The pre-selected rules that can be implemented in the present invention can be varied greatly and adjusted to the desired risk of a user. The invention will stimulate the development and testing of such rules.

An example of the different variations of how a cellular automata cell 200 is programmed with a pre-selected rule is as follows:

(1) Cell programmed with a pre-selected rule to simulate “follower” behavior:

```
If (Z(t)=BUY)&(SB(t)>SS(t)) then X(t+1)=BUY
else
  if (Z(t)=SELL)&(SB(t)<SS(t)) then X(t+1)=SELL
    else X(t+1)=X(t)
```

(2) Cell programmed with a pre-selected rule to simulate “contradictory” behavior:

```
If (Z(t)=BUY)&(SB>SS(T)) then X(t+1)=SELL
  else
    if (Z(t)=SELL)&(SB<SS(T)) then X(t+1)=BUY
      else X(t+1)=X(t)
```

(3) Cell programmed with a pre-selected rule to simulate “pioneer” behavior:

```
If (Z(t)=BUY) then X(t+1)=BUY
  else
    if (Z(t)=SELL) then X(t+1)=SELL
      else X(t+1)=X(t)
```

(4) Cell programmed with a pre-selected rule to simulate “emphatic”/“intuitive” behavior (where intentions are recognized):

```
If (SIB(t)>SIS(t))&(Z(t)=BUY) then X(t+1)=BUY
  else
    If (SIB(t)<SIS(t))&(Z(t)=SELL) then X(t+1)=SELL
      else X(t+1)=X(t)
```

(5) Cell programmed with a pre-selected rule to simulate “contra-intuitive” behavior (where intentions are recognized):

```
If (SIB(t)>SIS(t))&(Z(t)=SELL) then X(t+1)=BUY
  else
    If (SIB(t)<SIS(t))&(Z(t)=BUY) then X(t+1)=SELL
      else X(t+1)=X(t)
```

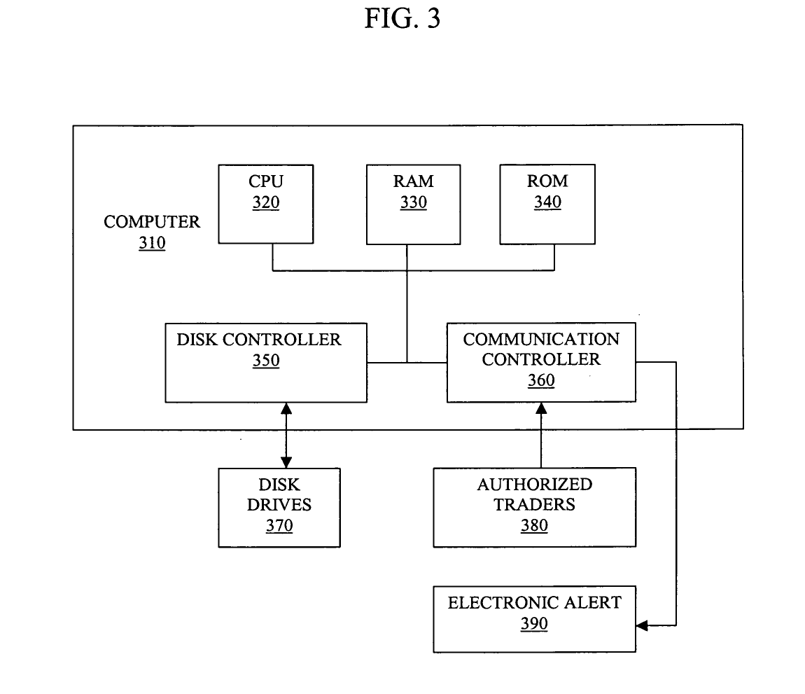

A computer 310 that may be used in the present invention is shown in FIG. 3. Computer 310 may be configured in a number of different forms for accepting input, processing the input according to specified instructions, and outputting the processing results, as is well known in the art. Computer 310 may be, for example, a personal computer, a workstation, a supercomputer, a mainframe computer, a minicomputer, a handheld computer, a wearable computing device, a personal digital assistant (“PDA”), a smart appliance in the home, and so forth. By way of example, computer 310 may function as a server in a client/server architecture in a networking environment; alternatively, computer 310 may be a client device in a client/server architecture, a device operating within another networking environment, or a stand-alone device not operating within a networking environment.

In accordance with the preferred embodiment of the present invention, a computer 310 preferably includes a central processing unit (“CPU”) 320, a random access memory (“RAM”) 330, a read-only memory (“ROM”) 340, a disk controller 350 and a communication controller 360.

CPU 320 is preferably one of the Intel families of microprocessors, one of the Advanced Micro Devices, Inc. families of microprocessors, one of the Motorola families of microprocessors, or one of the various versions of a Reduced Instruction Set (“RISC”) microprocessor such as the PowerPC® chip manufactured by IBM. In preferred embodiments, ROM 340 stores various controlling programs such as Basic Input-Output System (“BIOS”) developed by IBM. RAM 330 is preferably used for loading an operating system and selectively loading controlling programs and/or application programs.

Disk controller 350 may be an aggregate of controllers for facilitating interaction between CPU 320 and disk drives 370 and/or other types of data storage devices. Disk drive 370 is generally representative of a hard drive, floppy disk drive, compact-disk (“CD”) drive, etc. Preferably, an operating system (which in preferred embodiments is a conventional operating system such as AIX® from IBM or Windows® from Microsoft Corporation) is stored on a disk drive 370, for loading into memory.

Communication controller 360 may be an aggregate of controllers for facilitating interaction between CPU 320 and an authorized trader 380. According to preferred embodiments, communication controller 360 also facilitates interaction between CPU 320 and generating financial alerts 390.

Those of skill in the art will recognize that the components depicted in FIG. 3 are provided by way of example and are not intended to limit the present invention.

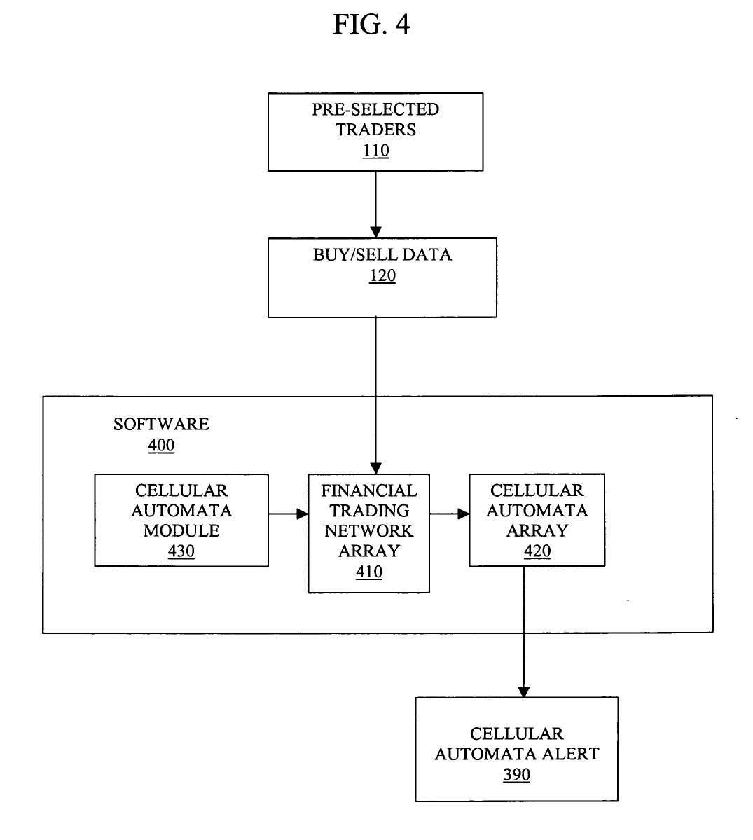

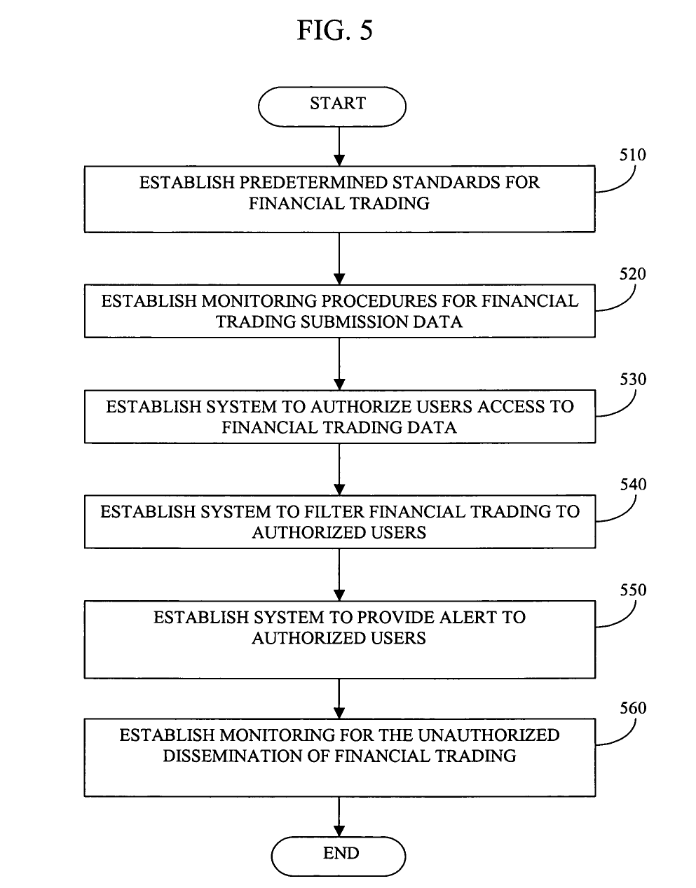

Referring now to FIG. 4, software 400 is illustrated. Software 400 preferably comprises one or more modules written in an object-oriented language, and executes on computer 310 of FIG. 3 to provide output of financial alerts and buying and selling decisions (shown in FIG. 5) under control of an operating system. The modules comprising software 400 may be physically stored within one or more fixed or removable computer-readable media that is electrically, magnetically, optically, chemically, or otherwise altered to store computer-readable program code, where this media is readable by a device such as disk drive 370.

In other embodiments of computer 310, software 400 may be stored in one or more other computer-readable media, such as a CD-ROM disk. Alternatively, software 400 or portions thereof may be downloaded to RAM 330 via network 390. In other embodiments of computer 310, software 400 can be partially or fully implemented with digital circuitry, analog circuitry, or a combination thereof.

The authorized traders 380 are preferably stored on one or more local or remote storage devices 370, and interacts with software 400 during operation of generating output of financial alerts and buying and selling decisions as disclosed herein.

In preferred embodiments, software 400 includes cellular automata module 430, a financial trading network array 410, and a cellular automata array module 420 for generating output related to financial trading according to preselected rules. In one embodiment of software 400, the cellular automata module 430, financial trading network array 410 and cellular automata array 420 incorporate a Structured Query Language (“SQL”) interface. An execution of the cellular automata module 430 under control of the operating system facilitates generating financial alerts and buying and selling decisions within disk drives 370 and other operations on this data (such as retrieving, querying, etc.), as will be obvious to one of skill in the art.

FIG. 5 provides a flow chart illustrating logic that may be used to implement preferred embodiments of the method of the present invention. As shown in FIG. 5, predetermined standards for financial trading are established 510. This establishment process may comprise identifying and mapping the financial data to the Virtual Trading Neighborhood. Monitoring procedures 520 are established in furtherance of determining compliance with the predetermined standards for submission of financial trading data. A system must be established to authorize users access the financial trading data 530. As financial trading data is submitted to form the Virtual Trading Neighborhood, a system is established to route or filter the output from the present invention to the authorized users 540.

Subsequent to those systems being established (510, 520, 530 and 540), a system is established to provide financial alerts to users 550. A system is also established to monitor the unauthorized dissemination of financial trading output generated by the present invention 560.

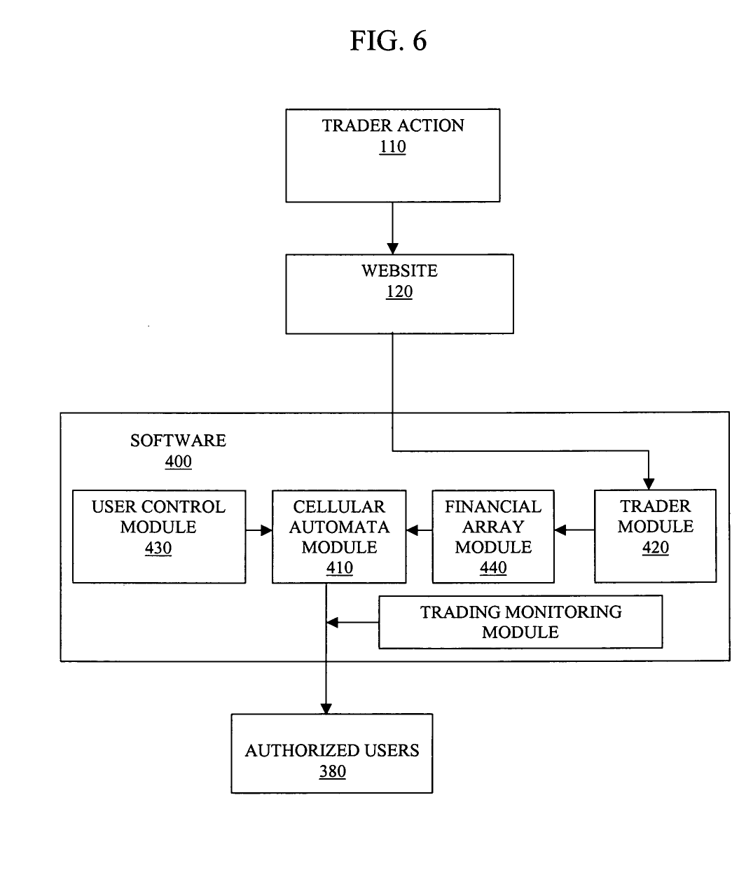

Referring now to FIG. 6, in an alternative embodiment, software 400 includes an user control module 430, a cellular automata module 410, a financial array module 440, and a trader module 420 for generating output of financial alerts and buy and sell decisions in accordance with the present invention.

As will be appreciated by one of skill in the art, embodiments of the present invention may be provided in various forms, including methods, systems, or computer program products. Accordingly, the present invention may take the form of an entirely hardware embodiment, an entirely software embodiment, or an embodiment combining software and hardware aspects. Furthermore, the present invention may take the form of a computer program product that is embodied on one or more computer-readable storage media (including, but not limited to, disk storage, CD-ROM, optical storage, and so forth) having computer-readable program code embodied therein.

The present invention has been described with reference to flow diagrams and/or block diagrams of methods, apparatus (systems), and computer program products according to preferred embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flow diagram flow or flows and/or block diagram block or blocks.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown. It is therefore evident that the particular embodiments disclosed above may be altered or modified and all such variations are considered within the scope and spirit of the invention.

It is also to be understood that the following claims are intended to cover all of the generic and specific features of the invention herein described, and all statements of the scope of the invention, which as a matter of language, might be said to fall therebetween.

Now that the invention has been described,

What is claimed is:

1. A method of organizing and processing financial data to generate alerts, comprising steps of:
establishing predetermined standards and criteria for organizing financial data submitted by authorized traders;
establishing a system to filter and group the financial data in accordance with the predetermined standards;
submitting the filtered financial data to a predetermined first array representing intentions to buy, intentions to sell, buying and selling;
processing the predetermined array to generate a second array according to preselected constraints and comprising a virtual trading neighborhood; and
analyzing the second array in accordance with risk criteria for providing a financial alert to authorized users.

2. The method according to claim 1, wherein the analysis of the second array is performed using cellular automata.

3. The method of claim 1, further comprising the step of establishing monitoring procedures of the financial data.

4. The method of claim 1, further comprising the step of establishing a system to authorize users access to the financial alert.

5. The method of claim 1, further comprising the step of establishing monitoring for the unauthorized dissemination of the financial alert.

6. The method of claim 1, further comprising the step of tagging financial alert so that it can be tracked to determine how the financial alert is being disseminated.

7. A system of processing financial data to generate alerts, comprising:
means for establishing predetermined standards for processing financial data submitted by authorized traders;
means for establishing a system to filter the financial data in accordance with the predetermined standards;
means for submitting the filtered financial data to a predetermined first array representing buying and selling
means for processing the predetermined array to generate a second array according to preselected constraints; and
means for analyzing the second array in accordance with risk criteria for providing a financial alert to authorized users.

8. The system according to claim 7, wherein the analysis of the second array is performed using cellular automata.

9. The system of claim 7, further comprising the step of establishing monitoring procedures of the financial data.

10. The system of claim 7, further comprising the step of establishing a system to authorize users access to the financial alert.

11. The system of claim 7, further comprising the step of establishing monitoring for the unauthorized dissemination of the financial alert.

12. The system of claim 7, further comprising the step of tagging financial alert so that it can be tracked to determine how the financial alert is being disseminated.

13. A computer program product for processing financial data to generate alerts, the computer program product embodied on one or more computer-readable media and comprising:
computer-readable program code means for establishing predetermined standards for processing financial data submitted by authorized traders;
computer-readable program code means for establishing a system to filter the financial data in accordance with the predetermined standards;
computer-readable program code means for submitting the filtered financial data to a predetermined first array representing buying and selling
computer-readable program code means for processing the predetermined array to generate a second array according to preselected constraints; and
computer-readable program code means for analyzing the second array in accordance with risk criteria for providing a financial alert to authorized users.

14. The computer program product according to claim 13, wherein the analysis of the second array is performed using cellular automata.

15. The computer program product according to claim 13, further comprising the step of establishing monitoring procedures of the financial data.

16. The computer program product according to claim 13, further comprising the step of establishing a system to authorize users access to the financial alert.

17. The computer program product according to claim 13, further comprising the step of establishing monitoring for the unauthorized dissemination of the financial alert.

18. The computer program product according to claim 13, further comprising the step of tagging financial alert so that it can be tracked to determine how the financial alert is being disseminated.
